(19) United States
(12) Patent Application Publication
(10) Pub. No.: US 2006/0228631 A1
(43) Pub. Date: Oct. 12, 2006

(54) Secondary battery electrode and non-aqueous electrolyte secondary battery using the same

(75) Inventors: Tamaki Miura, Yamato-shi (JP); Junji Katamura, Yokohama-shi (JP); Mikio Kawai, Yokosuka-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/332,466

(22) Filed: Jan. 17, 2006

(30) Foreign Application Priority Data
Jan. 18, 2005 (JP) 2005-010240
Oct. 25, 2005 (JP) 2005-309828

(51) Int. Cl. H01M 4/62; H01M 4/50; H01M 4/58; H01M 4/52

(52) U.S. Cl. 429/232; 429/224; 429/231.1; 429/223; 429/231.3; 429/221; 429/231.8

(57) ABSTRACT

A secondary battery electrode of the present invention has an electrode active material composed of particles with an average particle size of not more than 3 μm, and a conductive material contained in an amount of not less than 3 and less than 50 parts by weight with respect to 100 parts by weight of the electrode active material. The secondary battery electrode is capable of extracting a maximum effect of using fine particles as a constituent material.

### BACKGROUND OF THE INVENTION

1. Field of the Invention

The present invention relates to a secondary battery electrode and a non-aqueous electrolyte secondary battery using the same, and particularly, relates to a secondary battery electrode capable of contributing expression of a high power characteristic which could not have been achieved by a conventional secondary battery and a non-aqueous electrolyte secondary battery using the same.

2. Description of the Related Art

In recent years, secondary batteries for automobiles are requiring a characteristic of higher output power (see Japanese Patent Laid-open Publication No. 2004-111242). Some techniques to increase output power of the secondary batteries have hitherto been proposed, such as use of manganese component oxide of a Spinel structure with a BET specific surface of not less than 3 m²/g for a positive electrode and use of an electrode with a specific surface of not less than 4 m²/g (see Japanese Patent Laid-open Publications No. 7-97216 and No. 7-122262).

On the other hand, another high power battery has been proposed, which has cycle and output properties improved by not only increasing the specific surface but also making particle size of electrode constituent materials extremely small (Japanese Patent Laid-open publication No. 2003-151547).

### SUMMARY OF THE INVENTION

However, the particle size of the electrode constituent materials employed in the technology of the Japanese Patent Laid-open publication No. 2003-151547 often has a lower limit of not less than 5 μm. This is thought to be mainly because along with reduction of the particle size, proportions of the other solids including a binder used for forming the electrode are increased and accordingly an amount of the active material per unit weight, or capacity density, is reduced.

The extremely small particle size of the electrode constituent material has been confirmed to be able to exert an effect of increasing the output power more than an influence on the reduction of the capacity. However, particles with extremely small size, especially submicron size, have a large specific surface and include problems of contact resistance increased because of an increase in the number of contact points between particles and difficulty in maintaining conductivity at large current.

The present invention was made in the light of such problems involved in the conventional art, and an object of the present invention is to provide a secondary battery electrode capable of extracting a maximum effect of using fine particles as a constituent material of the secondary battery electrode and to provide a non-aqueous electrolyte secondary battery.

The first aspect of the present invention provides a secondary battery electrode comprising: an electrode active material composed of particles with an average particle size of not more than 3 μm; and a conductive material contained in an amount of not less than 3 and less than 50 parts by weight with respect to 100 parts by weight of the electrode active material.

The second aspect of the present invention provides a non-aqueous secondary battery comprising: an electrode comprising: an electrode active material composed of particles with an average particle size of not more than 3 μm; and a conductive material contained in an amount of not less than 3 and less than 5 parts by weight with respect to 100 parts by weight of the electrode active material.

### BRIEF DESCRIPTION OF THE DRAWINGS

The invention will now be described with reference to the accompanying drawings wherein;

FIG. 1 is a top view showing a non-aqueous electrolyte secondary battery of the present invention;

FIG. 2 is a cross-sectional view along a line II-II of FIG. 1;

FIG. 3 is a cross-sectional view of each coin cell produced in Examples and Comparative Examples;

FIG. 4 is a table showing compositions of the coin cells and test results in Examples and Comparative Examples;

FIG. 5 is a graph showing a relation between an amount of a conductive material and each property;

FIG. 6 is a graph showing a relation between a current value and a capacity retention ratio when particle size of an electrode active material is 1 μm and electrode thickness is 15 μm;

FIG. 7 is a graph showing the relation between the current value and the capacity retention ratio when the particle size of the electrode active material is 0.7 μm and the electrode thickness is 30 μm;

FIG. 8 is a graph showing a relation between the current value and the capacity retention ratio when the particle size of the electrode active material is 0.3 μm and the electrode thickness is 30 μm;

FIG. 9 is a SEM photograph (3000 times) of a cross-section of an electrode obtained in Example 1;

FIG. 10 is a SEM photograph (3000 times) of a cross-section of an electrode obtained in Example 2;

FIG. 11 is a SEM photograph (3000 times) of a cross-section of an electrode obtained in Example 3;

FIG. 12 is a SEM photograph (10000 times) of a cross-section of an electrode obtained in Example 9;

FIG. 13 is a SEM photograph (10000 times) of a cross-section of an electrode obtained in Example 10; and

FIG. 14 is a SEM photograph (10000 times) of a cross-section of an electrode obtained in Example 11.

### DETAILED DESCRIPTION OF PREFERRED EMBODIMENTS

Hereinafter, a description is given of a secondary battery electrode and a non-aqueous electrolyte secondary battery of the present invention in detail using the drawings.

The secondary battery electrode of the present invention includes an electrode active material and a conductive material. At this time, the electrode active material is composed of particles with an average particle size of not more than 3 μm. With respect to 100 parts by weight of the electrode active material, the conductive material is contained in an amount of not less than 3 and less than 50 parts by weight. As described above, using the active material with very small particle size and using the conductive material more than that of a conventional electrode ensure formation of conductive paths in the active material composed of particles, and resistance thereof becomes small, thus obtaining an electrode capable of increasing output power of the secondary battery.

Typical materials which can be used as the aforementioned active material are lithium manganese composite oxide, lithium nickel composite oxide, a lithium cobalt composite oxide, lithium nickel cobalt composite oxide, lithium manganese nickel cobalt composite oxide, lithium-containing iron oxide, graphite, amorphous carbon, and any combinations thereof. The above materials are effective because these materials can be easily prepared as particles with an average particle size of 3 μm.

From the viewpoint of increasing the output power of the secondary battery, the average particle size of the electrode active material is set to not more than 3 μm. However, from the viewpoint of further increasing the output power, preferably, the average particle size is not more than 1 μm. For example, it is preferable to use particles with particle size of 0.01 to 0.1 μm. In this specification, the particle size indicates median diameter (D50). As a method of forming particles of the above electrode active material, in addition to a method of adjusting synthesis conditions of the active material, for example, jet milling, wet bead milling and the like can be properly employed. Further, as a method of forming particles of the above electrode active material, a method of impacting liquids containing a large-sized electrode active material and a conductive material can be properly employed.

Typical materials which can be used as the aforementioned conductive material are carbon materials containing any one of or both of carbon black and graphite. At this time, the conductivity in the electrode is ensured, and high output power can be obtained if the electrode is used in the secondary battery. Examples of the above carbon black are acetylene black, Ketjen black, furnace black, and the like, and examples of the above graphite are flake, fiber, and block graphite. These materials may be naturally derived or synthetic.

Furthermore, from the viewpoint of suppressing reduction of electric capacity of the electrode, the above conductive material is contained in an amount of, preferably, 5 to 30 parts by weight with respect to 100 parts by weight of the electrode active material and, more preferably, 7 to 15 parts by weight. Still furthermore, it is desirable that the particle size of the above conductive material be 10 nm to 100 μm. The method of forming particles can be, in addition to adjusting the synthesis conditions of the conductive material, similar processing to that of the above electrode active material.

In the secondary battery electrode of the present invention, it is suitable that the electrode density is not more than 3.5 g/ml. Controlling the electrode density like this can provide the high power characteristic even when the amount of the conductive material is increased to form a bulky electrode. The electrode density is, more preferably, not more than 3.2 g/ml and, particularly preferably, not more than 3.0 g/ml. In this specification, the electrode density indicates a mass per unit volume of the entire active material, conductive material, and binder.

Preferably, the secondary battery electrode of the present invention contains polyvinylidene fluoride (PVDF) as the binder to bond the active material and conductive material. The electrode active material can be therefore uniformly dispersed even if formed into fine particles. Moreover, slurry thereof can be easily prepared in manufacturing. The secondary battery electrode can properly contain, as other materials of the binder, polyacrylonitrile (PAN), polyvinyl chloride (PVC), ethylene-propylene-diene terpolymer (EPDM), fluoride rubber (FR), butadiene rubber (BR), styrene-butadiene rubber (SBR), and the like.

The secondary battery electrode of the present invention may further contain an electrolyte. This is because filling gaps between particles of the active material in the electrode with the electrolyte allows smooth ion conduction in the electrode. Accordingly, the output power of the battery can be increased as a whole.

Using the aforementioned secondary battery electrode, a non-aqueous electrolyte secondary battery can develop a high power characteristic which has never been achieved before.

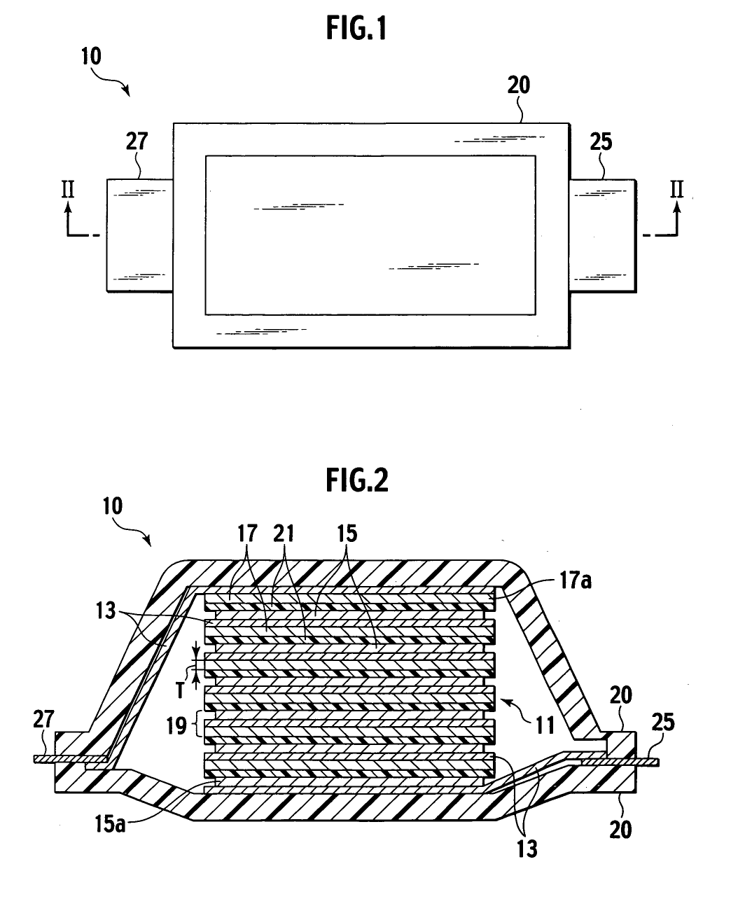

As shown in FIGS. 1 and 2, a non-aqueous electrolyte secondary battery 10 of the present invention includes a battery element 11, a laminate film 20, which covers the battery element 11, and tabs 25 and 27, which are drawn out of the laminate film 20.

The battery element 11 includes bipolar electrodes 19. Each of the bipolar electrodes 19 includes a positive electrode 15 on one side of a collector 13, and a negative electrode 17 on the other side. In the battery element 11, moreover, each of the bipolar electrodes 19 faces the adjacent bipolar electrode 19 with electrolyte 21 interposed therebetween. Specifically, the battery element 11 is composed of a structure in which the plurality of bipolar electrode 19, each including the positive electrode 15 on one side of the collector 13 and the negative electrode 17 on the other side, are stacked on each other with the electrolyte 21 interposed therebetween. Each of electrodes in top and bottom layers does not need to have the bipolar electrode structure and may have a structure in which a positive electrode 15a or a negative electrode 17a is disposed on one side of the collector 13. In the battery element 11, the collectors 13 in the upper and lower ends are joined to the positive and negative electrode tabs 25 and 27, respectively. The number of the stacked bipolar electrodes is adjusted according to desired voltage.

The aforementioned secondary battery electrode can be employed for at least one of the positive and negative electrodes 15 and 17. At this time, a positive electrode active material contained in the positive electrode 15 can be lithium manganese composite oxide, lithium nickel composite oxide, lithium cobalt composite oxide, lithium nickel cobalt composite oxide, lithium manganese nickel cobalt composite oxide, lithium-containing iron oxide, or the like. A negative electrode active material contained in the negative electrode 17 can be a carbon material such as graphite or amorphous carbon, metal oxide such as tin oxide or silicon oxide, lithium alloy such as lithium-aluminum alloy, lithium-tin alloy, or silicon alloy, or the like. As the electrolyte 21, a separator immersed in an electrolysis solution can be used, and the electrolysis solution can be a non-aqueous solvent with supporting salt dissolved. The non-aqueous solvent can be propylene carbonate (PC), ethylene carbonate (EC), dimethyl carbonate (DMC), methyl ethyl carbonate (MEC), diethyl carbonate (DEC), γ-butyl lactone (BL), and the like, which may be used singly or in combination. The supporting salt can be LiClO₄, LiPF₆, LiBF₄, LiAsF₆, or the like.

It is preferable that the collector 13 is metal foil or alloy foil of aluminum, cupper, stainless steel, or any combination thereof. At this time, the electrodes can be manufactured by applying slurry containing the active material with small particle size and the conductive material to the above metal or alloy foil, thus providing good productivity.

The thickness T of the electrode is not particularly limited. Generally, the thicknesses T of the positive electrode 15 and the negative electrode 17 range from 1 to 100 μm and, particularly preferably, range from 1 to 50 μm.

Hereinafter, a description is further given of examples and comparative examples in detail. However, the present invention is not limited to these examples.

As shown below, secondary battery electrodes of Examples 1 to 11 are the preferred embodiment of the present invention in which the content of the conductive material is varied for electrode thicknesses and particle sizes. A secondary battery electrode of Comparative Example 1 is an example including the positive electrode active material with excessively large particle size with respect to Example 2. A secondary battery electrode of Comparative Example 2 is an example not containing the conductive material, and a secondary battery electrode of Comparative Example 3 is an example containing an excessive amount of the conductive material.

### EXAMPLE 1

Lithium manganese composite oxide with an average particle size D50 of 1 μm as the positive electrode active material, carbon black as the conductive material, polyvinylidene fluoride (PVDF) as the binder, and N-methyl-2-pyrolydone (NMP) as the solvent were prepared. An electrode with an electrode composition of the positive electrode active material/the conductive material/the binder=85/5/10 was produced by the following operation. In the case of this electrode composition, the amount of the conductive material is 5.9 parts by weight with respect to 100 parts by weight of the positive electrode active material.

First, high purity anhydrous NMP was put into a dispersing mixer. Next, PVDF was put into the mixer and adequately dissolved in NMP. Thereafter, lithium manganese composite oxide and carbon black were put into the NMP with PVDF dissolved little by little to be blended with the NMP. When all the lithium manganese composite oxide and carbon black were put in, NMP was further added properly to adjust viscosity, thus obtaining slurry. The obtained slurry was applied to aluminum foil using a doctor blade with a constant thickness and dried on a hot stirrer. The thickness and density thereof were adjusted by a roll press, thus obtaining the secondary battery electrode. This electrode was good in visual observation in terms of dispersion, adhesion, and the like.

### EXAMPLE 2

The same operation as that of Example 1 was repeated except setting the electrode composition of the positive electrode active material/the conductive material/the binder to 80/10/10, thus obtaining the secondary battery electrode. In the case of this electrode composition, the amount of the conductive material was 12.5 parts by weight with respect to 100 parts by weight of the positive electrode active material. This electrode was good in visual observation in terms of the dispersion, the adhesion, and the like.

### EXAMPLE 3

The same operation as that of Example 1 was repeated except setting the electrode composition of the positive electrode active material/the conductive material/the binder being to 70/20/10, thus obtaining the secondary battery electrode. In the case of this electrode composition, the amount of the conductive material was 28.5 parts by weight with respect to 100 parts by weight of the positive electrode active material. Since the amount of the conductive material was increased, the amount of solvent necessary for slurrying was increased, and the solid-liquid ratio changed. This electrode was good in visual observation while the adhesion became slightly weak.

### EXAMPLE 4

The same operation as that of Example 1 was repeated except setting the electrode composition of the positive electrode active material/the conductive material/the binder being to 65/20/15, thus obtaining the secondary battery electrode. In the case of this electrode composition, the amount of the conductive material was 31 parts by weight with respect to 100 parts by weight of the positive electrode active material. Since the amounts of the conductive material and binder were increased, the amount of solvent necessary for slurrying was increased, and the solid-liquid ratio changed. This electrode was good in visual observation in terms of the dispersion, the adhesion, and the like.

### EXAMPLE 5

The same operation as that of Example 1 was repeated except setting the electrode composition of the positive electrode active material/the conductive material/the binder to 55/25/20, thus obtaining the secondary battery electrode. In the case of this electrode composition, the amount of the conductive material was 31 parts by weight with respect to 100 parts by weight of the positive electrode active material. Since the amount of the conductive material was increased, the amount of solvent necessary for slurrying was increased, and the solid-liquid ratio changed. This electrode was good in visual observation although the adhesion became slightly weak.

### EXAMPLE 6

The same operation as that of Example 1 was repeated except using the positive electrode active material with an average particle size D50 of 0.7 μm and setting the electrode composition of the positive electrode active material/the conductive material/the binder being to 85/5/10, thus obtaining the secondary battery electrode. In the case of this electrode composition, the amount of the conductive material was 5.9 parts by weight with respect to 100 parts by weight of the positive electrode active material. This electrode was good in visual observation in terms of the dispersion, the adhesion, and the like.

### EXAMPLE 7

The same operation as that of Example 1 was repeated except using the positive electrode active material with an average particle size D50 of 0.7 μm and setting the electrode composition of the positive electrode active material/the conductive material/the binder to 80/10/10, thus obtaining the secondary battery electrode. In the case of this electrode composition, the amount of the conductive material was 12.5 parts by weight with respect to 100 parts by weight of the positive electrode active material. This electrode was good in visual observation in terms of the dispersion, the adhesion, and the like.

### EXAMPLE 8

The same operation as that of Example 1 was repeated except using the positive electrode active material with an average particle size D50 of 0.7 μm and setting the electrode composition of the positive electrode active material/the conductive material/the binder to 70/20/10, thus obtaining the secondary battery electrode. Since the conductive material was increased, the amount of solvent for slurrying was increased, and the solid-liquid ratio changed. In the case of this electrode composition, the amount of the conductive material was 28.5 parts by weight with respect to 100 parts by weight of the positive electrode active material. This electrode was good in visual observation although the adhesion was slightly weak.

### EXAMPLE 9

The same operation as that of Example 1 was repeated except using the positive electrode active material with an average particle size D50 of 0.3 μm and setting the electrode composition of the positive electrode active material/the conductive material/the binder being to 80/10/10, thus obtaining the secondary battery electrode. In the case of this electrode composition, the amount of the conductive material was 12.5 parts by weight with respect to 100 parts by weight of the positive electrode active material. This electrode was good in visual observation in terms of the dispersion, the adhesion, and the like.

### EXAMPLE 10

The same operation as that of Example 1 was repeated except using the positive electrode active material with an average particle size D50 of 0.3 μm and setting the electrode composition of the positive electrode active material/the conductive material/the binder to 70/20/10, thus obtaining the secondary battery electrode. In the case of this electrode composition, the amount of the conductive material was 28.5 parts by weight with respect to 100 parts by weight of the positive electrode active material. Since the amount of the conductive material was increased, the amount of solvent necessary for slurrying was increased, and the solid-liquid ratio changed. However, this electrode was good in visual observation in terms of the dispersion, the adhesion, and the like.

### EXAMPLE 11

The same operation as that of Example 1 was repeated except using the positive electrode active material with an average particle size D50 of 0.3 μm, using carbon black different from that of Example 10 as the conductive material, and setting the electrode composition of the positive electrode active material/the conductive material/the binder to 80/10/10, thus obtaining the secondary battery electrode. In the case of this electrode composition, the amount of the conductive material was 28.5 parts by weight with respect to 100 parts by weight of the positive electrode active material. Since the amount of the conductive material was increased, the amount of solvent necessary for slurrying was increased, and the solid-liquid ratio changed. This electrode was good in visual observation in terms of the dispersion, the adhesion, and the like. Moreover, there was no difference observed in slurry and electrode conditions between the different types of the conductive material.

### COMPARATIVE EXAMPLE 1

The same operation as that of Example 1 was repeated except using the positive electrode active material with an average particle size D50 of 10 μm and setting the electrode composition of the positive electrode active material/the conductive material/the binder to 80/10/10, thus obtaining the secondary battery electrode. In the case of this electrode composition, the amount of the conductive material was 12.5 parts by weight with respect to 100 parts by weight of the positive electrode active material.

### COMPARATIVE EXAMPLE 2

The same operation as that of Example 1 was repeated except using the positive electrode active material with an average particle size D50 of 1 μm, not using the conductive material, and setting an electrode composition of the positive electrode active material/the binder being to 90/10, thus obtaining the secondary battery electrode.

### COMPARATIVE EXAMPLE 3

The same operation as that of Example 1 was repeated except using the positive electrode active material with an average particle size D50 of 1 μm and setting the electrode composition of the positive electrode active material/the conductive material/the binder being to 50/30/20, thus obtaining the secondary battery electrode. In the case of this electrode composition, the amount of the conductive material was 60 parts by weight with respect to 100 parts by weight of the positive electrode active material.

(Constant Current Charge/Discharge Test)

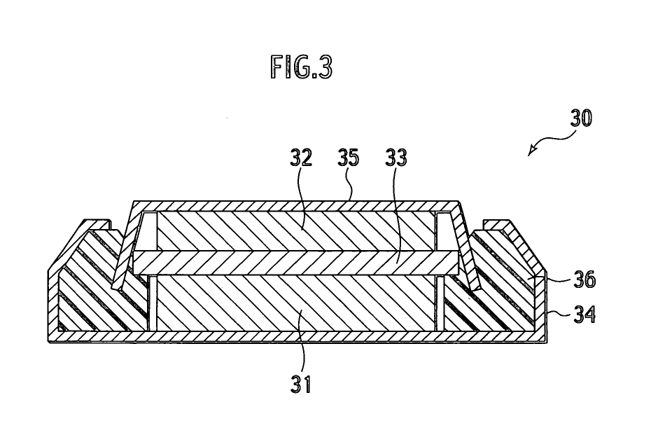

As shown in FIG. 3, using a positive electrode 31, which was formed by stamping out each obtained electrode with a φ15 mm jig, a negative electrode 32 of Li metal with φ15 mm, and a separator 33 of φ18 mm, a coin cell 30 was produced. In FIG. 3, reference numerals 34, 35, and 36 denote an outer jacket, a battery lid, and sealant filling gap between the outer jacket 34 and the battery lid 35, respectively. The separator 33 held electrolyte solution. The electrolyte solution was obtained by dissolving LiPF₆ in a solvent containing propylene carbonate (PC) and ethylene carbonate (EC) at a volume ratio of 1/1 into 1M.

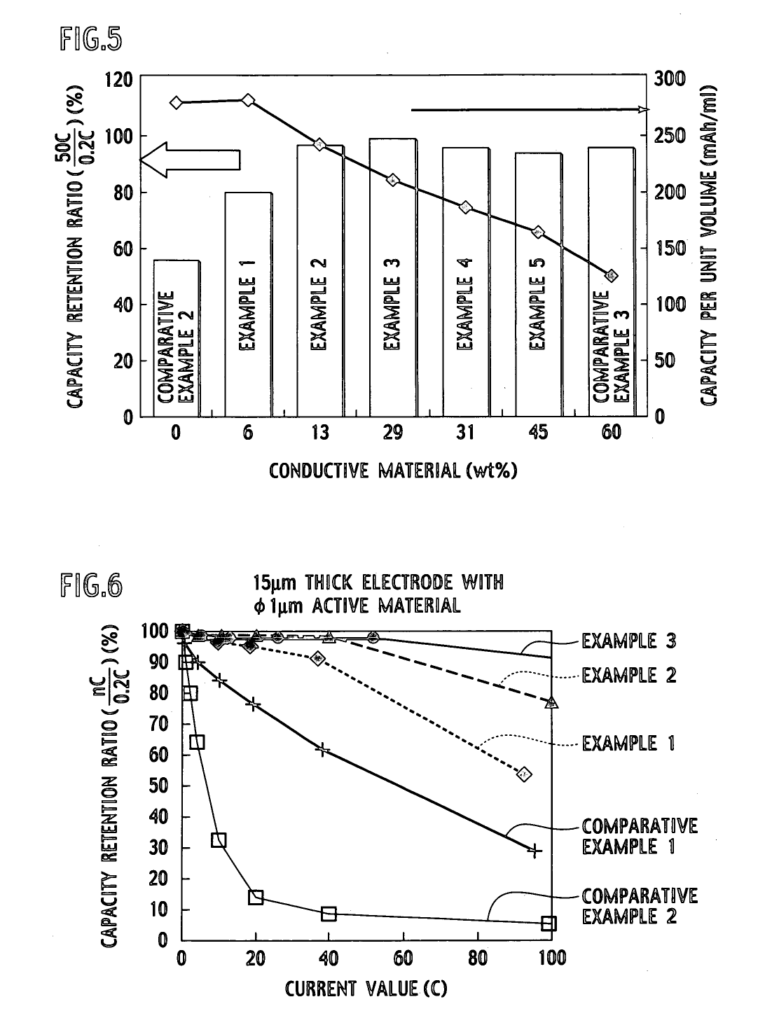

Using the above coin cells, a measurement was carried out under conditions: evaluation temperature of 20° C., a voltage range of 3 to 4.3 V, and a current value 1 C of 500 μA. Moreover, the discharge characteristic was checked at large current up to 100 C. This “C” indicates a discharge rate. 1 C is such a current value that a cell with a capacity of a nominal capacity value is subjected to constant current discharge and the discharge is finished in just one hour. For example, in a cell with a nominal capacity value of 2.2 Ah, 1 C is 2.2 A. 0.2 C is such a current value that discharge of a cell with a capacity of the nominal capacity value is finished in five hours. In the cell with a nominal capacity value of 2.2 Ah, 0.2 C is 0.44 A. In FIGS. 5 to 8, the discharge characteristic is indicated by a capacity retention ratio. In FIG. 5, the capacity retention ratio is a ratio of a discharge capacity at 50 C to a discharge capacity at 0.2 C. In FIGS. 6 to 8, the capacity retention ratio is a discharge capacity at nC to a discharge capacity at 0.2 C, where n denotes a current value (C) on a graph horizontal axis.

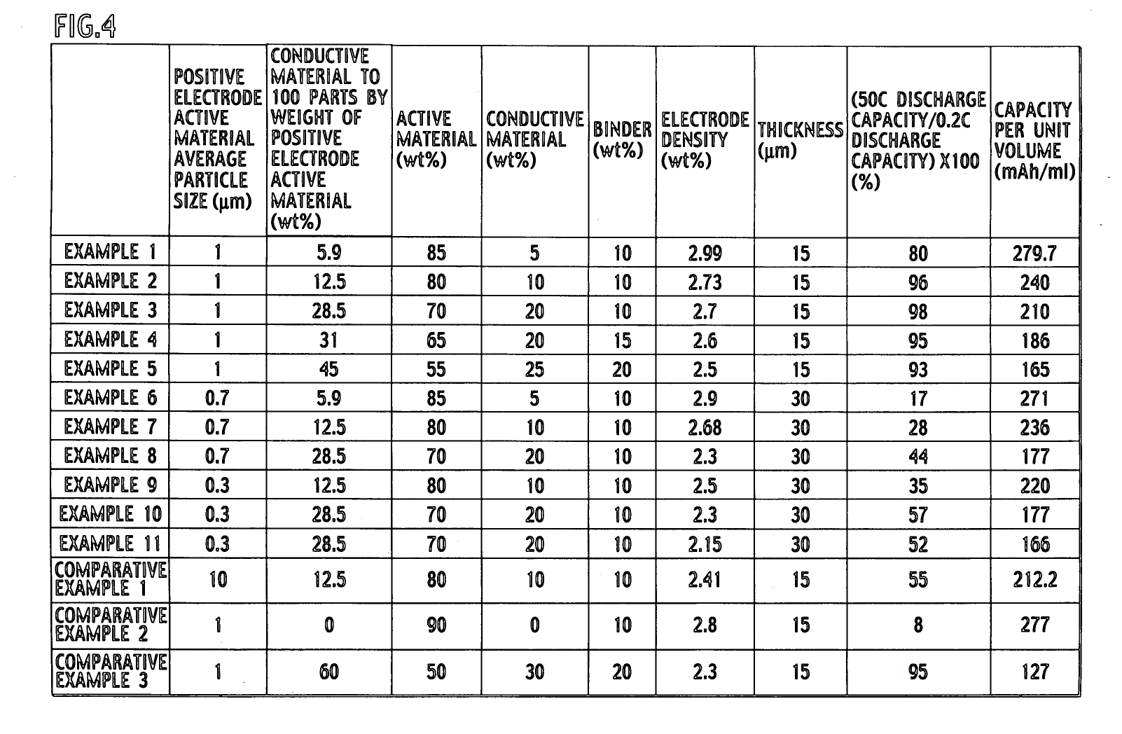

Generally, capacity which can be extracted from a battery changes depending on magnitude of discharge current. Specifically, the larger the discharge current is, the smaller the capacity is, and the smaller the discharge current is, the larger the capacity is. The discharge characteristic (capacity retention ratio) indicating the ratio of discharge capacity at large current to discharge capacity at minute current is thought to be substantially equivalent to the magnitude of internal resistance of the electrode and have an influence on the output characteristic of the electrode. Specifically, in the case where the capacity retention ratio is high even when the current value nC is large, the internal resistance of the electrode is small, so that a large discharge capacity can be obtained even at large discharge current. However, the thicker the electrode is, the higher the internal resistance is. Accordingly, in these Examples, no results could be obtained at 100 C for the electrodes with a thickness of 30 μm. The obtained results are shown in FIG. 4.

FIG. 4 shows the average particle size obtained by the particle size distribution measurement, the weight ratio of the conductive material to the positive electrode active material among the electrode composition of each active material, electrode composition, electrode density, electrode thickness, and the ratio of discharge capacity at 50 C to discharge capacity at 0.2 C in the coin cell measurement, and the capacity per unit volume of each electrode.

The particle size measurement basically uses a laser diffraction method. However, when the particle size is not more than 0.3 μm, which is smaller than instrument precision, the measurement cannot be carried out. Accordingly, the measurement was carried out by a dynamic scattering method for such a case.

FIG. 5 shows the capacity retention ratio related to the electrodes with an average particle size D50 of 1 μm and a thickness of 15 μm among the electrodes of FIG. 4. This graph revealed that as the amount of the conductive material increased, the ratio of discharge capacity at large current to discharge capacity at small current increased. On the other hand, as shown in the drawing, there was a tendency that as the proportion of the conductive material, which was a carbon material with a true density lower than that of the active material, was increased, the capacity per unit volume of the electrode was reduced. The proportion of the conductive material is therefore a value influencing the energy density of the battery.

Concretely, in the case of using the electrode obtained in Comparative Example 2, it can be thought that the resistance was large because the amount of the conductive material was too small so that a good output characteristic could not be obtained despite of the large capacity of the electrode. In the case of using the electrode obtained in Comparative Example 3, the conductive material was too much, and the proportion of the active material was reduced, so that the capacity per unit volume was extremely reduced while the output characteristic was good.

Based on the above tendency, it is preferred to use the minimum amount of conductive material required to improve the output characteristic.

In the graph of FIG. 6, a comparison was made in terms of the discharge characteristic for the electrodes with a thickness of 15 μm and a capacity per unit volume of not less than 200 Ah/ml among the electrodes of FIG. 4. It was confirmed in this graph that as the particle size of the active material was reduced and the amount of the conductive material was increased, the reduction of the capacity was reduced even when the discharge current value was greatly changed.

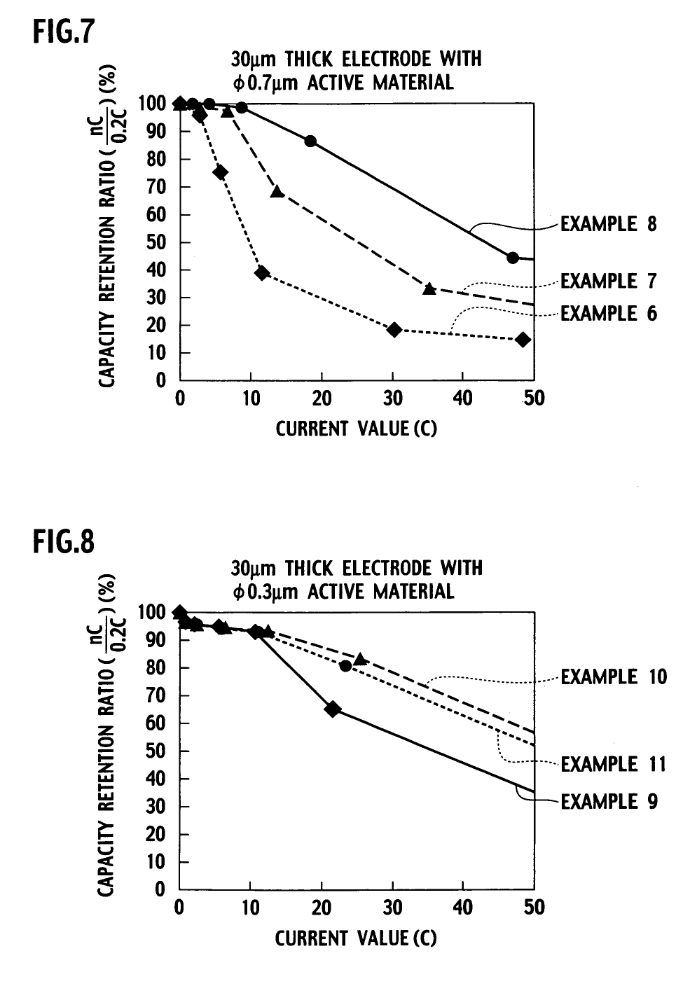

The graph of FIG. 7 shows the discharge characteristic of the electrodes using the active material with an average particle size of 0.7 μm and having a thickness of 30 μm among the electrodes of FIG. 4. The graph of FIG. 8 shows the discharge characteristic of the electrodes using the active material with an average particle size of 0.3 μm and having a thickness of 30 μm among the electrodes of FIG. 4. In either case, the discharge characteristic is improved as the amount of the conductive material is increased although the absolute values of the capacity retention ratios are smaller than those of the electrodes of FIG. 6. FIG. 8 also shows a comparison between the electrodes using different types of the conductive material, but it is impossible to insist on a difference in discharge characteristic depending on the type of the conductive material from this result.

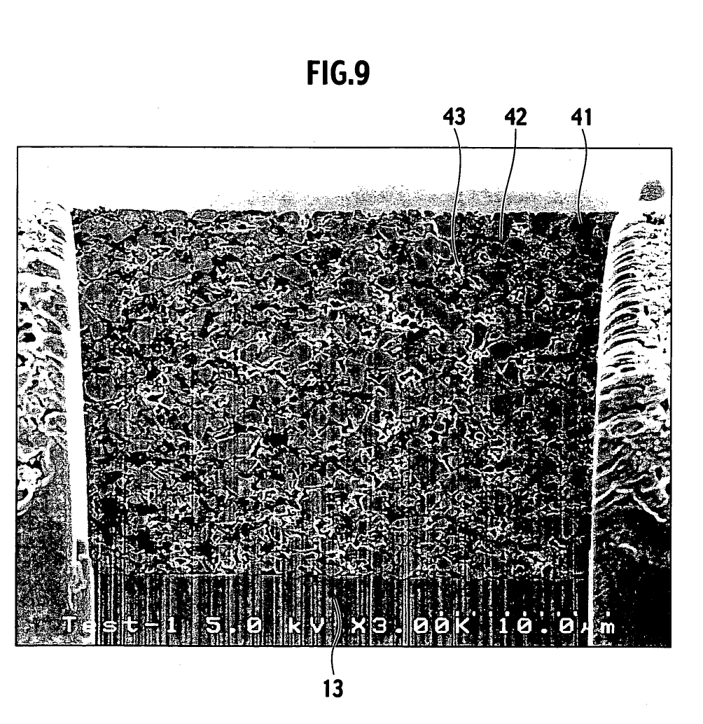

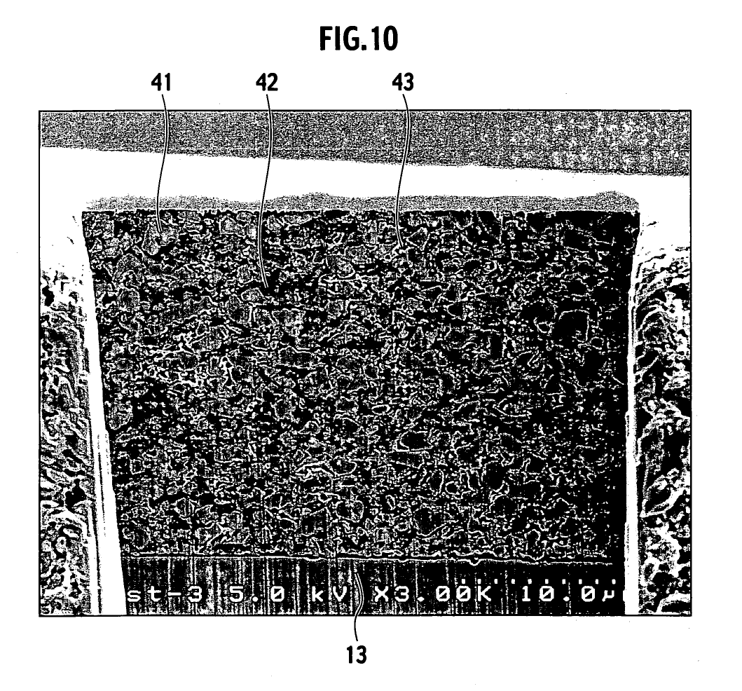

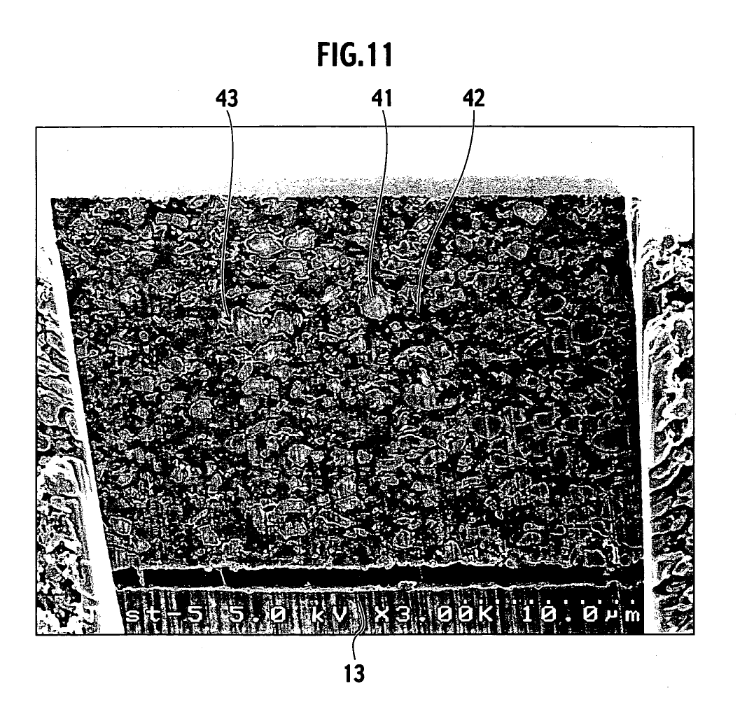

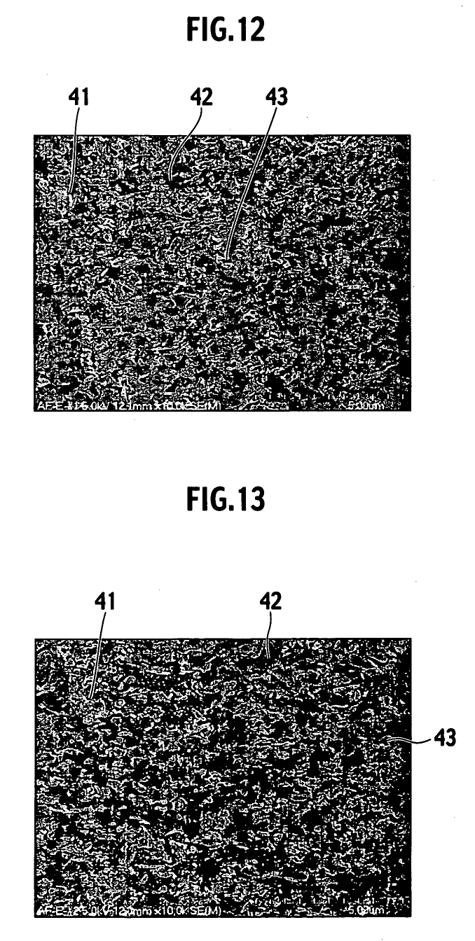

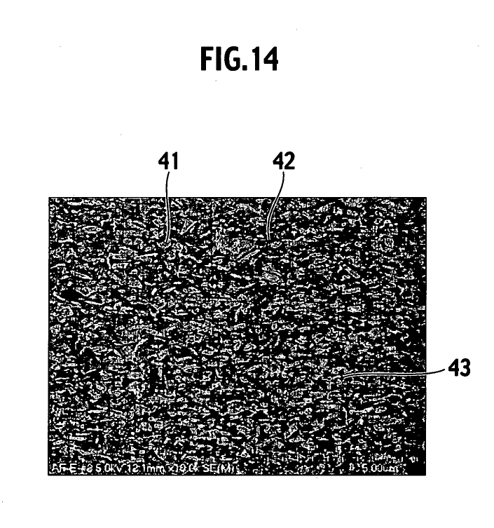

Furthermore, FIGS. 9 to 14 show SEM photographs of the observation of the cross-sections of Examples 1 to 3 and 9 to 11, respectively. In the drawings, reference numerals 41, 42, and 43 denote the positive electrode active material, conductive material, and gaps, respectively. These photographs show that large gaps in the electrode were reduced and further filled along with the increase in the amount of conductive material and a network of the material with conductivity was surely formed.

While the internal resistance is reduced along with the increase in the amount of the conductive material to improve the discharge characteristic, it is described above from the graph of FIG. 5 that the capacity per unit volume is reduced along with the increase in the amount of the conductive material. The capacity per unit volume is a value influencing the energy density of the battery, and design needs to consider the balance between the cell capacity and output power.

As described above, to increase the output power of the current electrode, it is necessary to use an active material with an average particle size of not more than 3 μm and use not less than 3 parts by weight of the conductive material with respect to 100 parts by weight of the electrode active material. On the other hand, as the amount of the conductive material is increased, the output power is increased. The effect thereof is better for less than 50 parts by weight, and effectively better for not more than 30 parts by weight. When the amount of the conductive material exceeds 30 parts by weight, the capacity of the electrode is reduced, thus causing difficulty in forming the electrode. In order to increase the output power with the reduction of the capacity suppressed, it is desirable to add not less than 5 parts by weight and, preferably, about 7 to 15 parts by weight of the conductive material.

The entire contents of Japanese Patent Applications No. P2005-10240 with a filing date of Jan. 18, 2005 and No. P2005-309828 with a filing date of Oct. 25, 2005 are herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A secondary battery electrode, comprising:
an electrode active material composed of particles with an average particle size of not more than 3 μm; and
a conductive material contained in an amount of not less than 3 and less than 50 parts by weight with respect to 100 parts by weight of the electrode active material.

2. The secondary battery electrode of claim 1,
wherein the average particle size of the electrode active material is not more than 1 μm.

3. The secondary battery electrode of claim 1,
wherein the conductive material is contained in an amount of not less than 5 but not more than 30 parts by weight with respect to the 100 parts by weight of the electrode positive material.

4. The secondary battery electrode of claim 3,
wherein the conductive material is contained in as amount of not less than 7 but not more than 15 parts by weight with respect to the 100 parts by weight of the electrode positive material.

5. The secondary battery electrode of claim 1,
wherein the electrode active material contains at least one selected from a group consisting of lithium manganese composite oxide, lithium nickel composite oxide, lithium cobalt composite oxide, lithium nickel cobalt composite oxide, lithium manganese nickel cobalt composite oxide, lithium-containing iron oxide, graphite, and amorphous carbon.

6. The secondary battery electrode of claim 1,
wherein the conductive material is a carbon material containing one of carbon black and graphite.

7. The secondary battery electrode of claim 1,
wherein density of the electrode is not more than 3.5 g/ml.

8. The secondary battery electrode of claim 1, further comprising:
a binder composed of polyvinylidene fluoride.

9. The secondary battery electrode of claim 1,
wherein a thickness of the secondary battery electrode ranges from 1 to 100 μm.

10. A non-aqueous secondary battery, comprising:
an electrode comprising: an electrode active material composed of particles with an average particle size of not more than 3 μm; and a conductive material contained in an amount of not less than 3 and less than 5 parts by weight with respect to 100 parts by weight of the electrode active material.

11. The non-aqueous secondary battery of claim 10, further comprising:
a collector which is in contact with the electrode and composed of a metal foil or an alloy foil of at least one selected from a group consisting aluminum, copper, and stainless steel.

12. The non-aqueous secondary battery of claim 10,
wherein a thickness of the electrode ranges from 1 to 100 μm.
